(19) United States
(12) Patent Application Publication
(10) Pub. No.: US 2026/0261872 A1
(43) Pub. Date: Sep. 3, 2026

(54) SYSTEMS AND METHODS FOR OPTIMIZING SERVICE OUTAGE IMPACT BY MINIMIZING ACTIVE USERS IN A NETWORK

(71) Applicant: JIO PLATFORMS LIMITED, Ahmedabad (IN)

(72) Inventors: Rishi Raj KOUL, New Delhi (IN); Siddharth Shanker SINGH, Faridabad (IN); Uday Shankar SHANBHAG, Mumbai (IN); Virag PATEL, Thane (IN); Neeraj HAMPAL, New Delhi (IN)

(73) Assignee: JIO PLATFORMS LIMITED, Ahmedabad (IN)

(21) Appl. No.: 18/873,405

(22) PCT Filed: Jun. 29, 2023
(86) PCT No.: PCT/IB2023/056777

§ 371 Date: Dec. 10, 2024

(30) Foreign Application Priority Data
Jun. 29, 2022 (IN) 202221037229

(51) Int. Cl. H04W 24/02; H04W 24/04; H04W 24/08

(52) U.S. Cl. CPC H04W 24/02; H04W 24/04; H04W 24/08

(57) ABSTRACT

The present disclosure provides system and method for optimizing service outage impact in a network. System receives at least one data packet including one or more parameters from one or more computing devices associated with one or more active users within at least one cell. The one or more parameters comprise network Key Performance Indicators (KPI), alarm, and fault. Further, the system analyzes the data packet to identify one or more patterns of time series, and correlate with the one or more parameters. Finally, the system predicts a lean hour of the one or more computing devices, and performs changes in a configuration of the one or more computing devices in lean hour to minimize the active users and optimize service outage impact in a network.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to telecommunication deployment. More particularly, the present disclosure relates to a system and a method for optimizing service outage impact by minimizing active users in a network.

### BACKGROUND OF THE INVENTION

The following description of the related art is intended to provide background information pertaining to the field of disclosure. This section may include certain aspects of the art that may be related to various features of the present disclosure. However, it should be appreciated that this section be used only to enhance the understanding of the reader with respect to the present disclosure, and not as admissions of prior art.

The formation of Global System for Mobile Communications Association (GSMA) paved the way to the standardization of wireless telephony and the easy availability and adaptability of core technical knowledge leading to increased adaptation and increased demand. The standardization of wireless telephony was also augmented by improvements in chip design resulting in lower power consumption and higher integration. Further, lower power consumption and denser components made faster processing possible that allowed engineers to roll out new features that were thought impossible earlier because of hardware limitations. Furthermore, a new feature or software release would typically be executed in 4 to 5 years, but of late the modern world has adapted to software releases and features being pushed into the networks every 3 to 4 months. All new releases involve restarting the telecom nodes resulting in service disruption to the end users. Apart from this many user-settable parameters, if changed, need a restart of the node to become effective, this also leads to service disruption when such parameter values are optimized by the operation teams.

In order to provide the best service experience to the end users, the telecom network is in a constant state of expansion, upgrade, and optimization. All such activities involve a change in the configuration of existing nodes, the inclusion of new nodes to address increased demand, and rolling out new features in the form of software, firmware upgrades, and parameter value changes. Most of the time the configuration changes involve the disruption of existing services for a limited period. The service disruption is experienced by all the users that are using the network (Active users) at that time.

However, the existing systems for enabling configuration changes involve a network operator to address the issue promptly, investigate the cause of the disruption, and work towards restoring normal network operations to minimize the impact on the active users. The network operator has employed various ways to minimize the number of customers that experience this service disruption by deploying the new software configuration changes at the night times assuming the number of active users will be less at that time. Even though this reduces the impact of service disruption, but still it can be improved by a lot as was demonstrated by our case study of Mumbai City in India.

There is, therefore, a need in the art to provide a method and a system that can overcome the shortcomings of the existing prior arts.

### Objects of the Present Disclosure

Some of the objects of the present disclosure, which at least one embodiment herein satisfies are as listed herein below.

An object of the present disclosure is to provide a system and method for optimizing service outage impact by minimizing active users in a network.

An object of the present disclosure is to provide a system and a method of an enhanced mechanism for executing configuration changes in the network by enabling the changes in individual cell lean hours to minimize the number of active users experiencing service disruption.

An object of the present disclosure is to provide a system and a method for user scalability and flexibility according to the requirement of the individual active user during configuration changes.

An object of the present disclosure is to provide a system and a method to minimize temporary disruption of services due to which users may not encounter data packet loss, leading to errors or incomplete transmission of data, resulting in disrupted or degraded user experiences.

An object of the present disclosure is to provide a system and a method to schedule service-impacting configuration changes during off-peak hours or low-demand periods to minimize the number of active users affected.

An object of the present disclosure is to provide a system and a method with enhanced user satisfaction by minimizing the number of users affected by a service disruption which helps maintain a higher level of user satisfaction.

An object of the present disclosure is to provide a system and a method that conducts service-impacting configuration changes during lean hours providing the network administrators with a less congested and more manageable environment for implementing the changes.

An object of the present disclosure is to provide a system and a method that facilitates smoother implementation processes, reduced risk of errors, and improved overall efficiency.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for optimizing service outage impact in a network. The system includes one or more processors, and a memory operatively coupled with the one or more processors, where the memory stores instructions which, when executed, cause the one or more processors to receive at least one data packet including one or more parameters from one or more computing devices associated with one or more active users within at least one cell. Further, the one or more processors are configured to analyze the at least one data packet to identify one or more patterns of a time series, and correlate with the one or more parameters. Furthermore, the one or more processors are configured to predict a lean hour of the one or more computing devices based on the time series forecasting of the at least one data packet. Finally, the one or more processors are configured to perform changes in a configuration of the one or more computing devices in the lean hour in order to minimize the one or more active users and optimize service outage impact in the network.

In an embodiment, the one or more parameters may include at least one of a network Key Performance Indicators (KPI), an alarm, and a fault.

In an embodiment, the one or more patterns may include at least one of a trend, a seasonality, a white noise, and a random noise.

In an embodiment, the one or more processors may be configured to receive the at least one data packet from the one or more computing devices based on a predefined time. The predefined time may pertain to an aggregation of the at least one data packet in an hourly bin on a daily basis.

In an embodiment, the one or more processors may be configured to verify whether a status of the one or more computing devices corresponds to the lean hour. Further, the one or more processors may be configured to schedule an activity time for the one or more computing devices based on the lean hour. The activity time may pertain to executing network service impacting configuration change operations in the one or more computing devices.

In an embodiment, the network service impacting configuration change operations may include at least one of a firmware upgrade, a network equipment reconfiguration, a network service migration, and an optimization of a network capacity.

In an embodiment, the one or more processors may be configured to obtain the time series forecasting based on sorting the at least one data packet, and eliminate one or more outliers to predict the lean hour of the one or more computing devices.

In an embodiment, the lean hour of the one or more computing devices may be predicted based on one or more categories of the one or more active users of the one or more computing devices. The one or more categories may include at least one of a lightly loaded category, a moderately loaded category, and a heavily loaded category.

In an embodiment, the time series may pertain to a set of one or more observations, with each observation associated with a specific time index.

In an aspect, the present disclosure relates to a method for optimizing service outage impact in a network. The method includes receiving, by one or more processors, at least one data packet including one or more parameters from one or more computing devices associated with one or more active users within at least one cell. The method includes analyzing, by the one or more processors, the at least one data packet to identify one or more patterns of a time series, and correlate with the one or more parameters. The method includes predicting, by the one or more processors, a lean hour of the one or more computing devices based on time series forecasting. Finally, method includes performing, by the one or more processors, changes in the configuration of the one or more computing devices in the lean hour by minimizing the one or more active users and optimizing service outage impact in the network.

In an aspect, the present disclosure relates to a user equipment (UE). The UE includes one or more processors coupled with a memory, where the memory stores instructions which, when executed, cause the one or more processors to identify one or more temporary service disruptions during a configuration process. The one or more processors are configured to transmit at least one data packet including one or more parameters to a system in a cell. The one or more parameters may include at least one of a network KPI, an alarm, and a fault. The one or more processors are configured to receive and execute one or more instructions from the system during a predicted lean hour based on the time series forecasting to optimize service outage impact in the network.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that invention of such drawings includes the disclosure of electrical components, electronic components or circuitry commonly used to implement such components.

FIG. 1 illustrates exemplary network architecture (100) in which or with which embodiments of the present disclosure may be implemented.

FIG. 2 illustrates an exemplary block diagram (200) of the proposed system, in accordance with an embodiment of the present disclosure.

FIG. 3 illustrates an exemplary representation (300) of the process block diagram architecture, in accordance with an embodiment of the present disclosure.

FIG. 4A illustrates an exemplary flow diagram (400) of the proposed method, in accordance with an embodiment of the present disclosure.

FIG. 4B illustrates an exemplary representation (450) of active user loading in a network in different hours in a day, in accordance with embodiments of the present disclosure.

FIG. 5 illustrates an exemplary computer system (500) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present disclosure provides a robust and an effective solution to implement a system and a method for optimizing service outage impact by minimizing active users in a network. The proposed system incorporates scheduling changes in network services which impact configuration changes during off-peak hours or low-demand periods of one or more computing devices in a cell of the network in order to minimize the number of active users affected by the disruption.

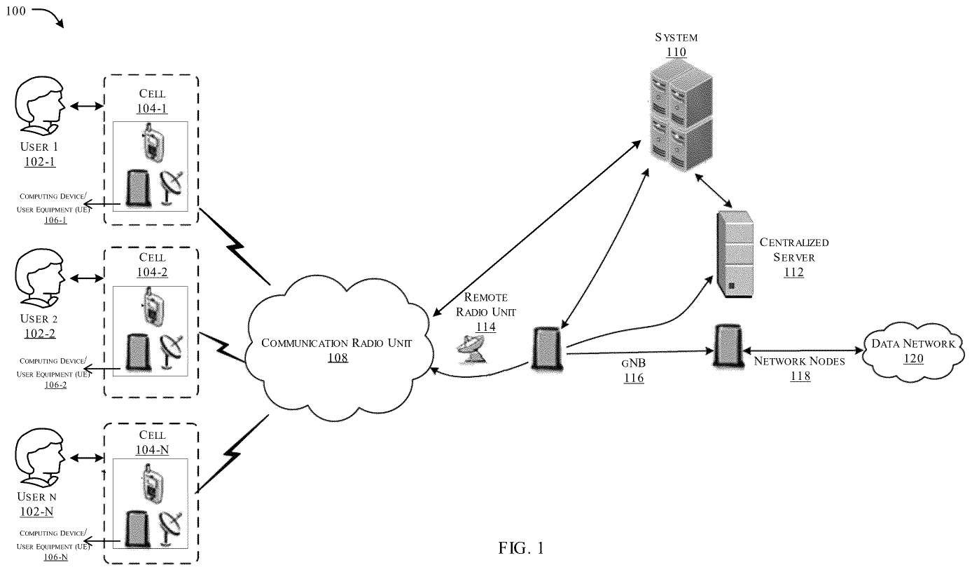

The various embodiments throughout the disclosure will be explained in more detail with reference to FIGS. 1-5.

FIG. 1 illustrates an exemplary network architecture 100 in which or with which embodiments of the present disclosure may be implemented.

Referring to FIG. 1, the exemplary network architecture 100 is depicted in which or with which a system 110 for optimizing service outage impact by minimizing active users in a network may be implemented. As illustrated, the system 110 may receive at least one data packet including one or more parameters from one or more computing devices (106-1, 106-2 . . . 106-N) associated with one or more users (102-1, 102-2 . . . 102-N) within at least one cell (104-1, 104-2 . . . 104-N).

In an embodiment, the system 110 may be communicatively coupled to the one or more computing devices (106-1, 106-2 . . . 106-N) through a communication network 108. A person of ordinary skill in the art will understand that one or more computing devices (106-1, 106-2 . . . 106-N) may be individually referred to as computing device 106 and collectively referred to as computing devices 106. Similarly, one or more users (102-1, 102-2 . . . 102-N) may be individually referred to as user 102 and/or active user 102 and collectively referred to as users 102 and/or active users 102. Similarly, at least one cell (104-1, 104-2 . . . 104-N) may be individually referred to as cell 104 and collectively referred to as cells 104. In an embodiment, the computing device 106 may also be referred to as User Equipment (UE). Accordingly, the terms “computing device” and “User Equipment (UE)” may be used interchangeably throughout the disclosure.

In an exemplary embodiment, the computing device 106 may include one or more processing units such as, but not limited to, a data transmitting unit, a data management unit, a display unit, and other units, wherein the other units may include, without limitation, a storage unit, a computing unit, and/or a signal generation unit.

In an embodiment, the computing device 106 may transmit the at least one data packet including one or more parameters over a point-to-point or point-to-multipoint communication channel or network 108 to the system 110.

In an embodiment, the computing device 106 may involve collection, analysis, and sharing of data received from the system 110 via the communication network 108. In an embodiment, the computing device 106 may enable presentation of information to the one or more users 102.

In an embodiment, the system 110 may receive at least one data packet including one or more parameters from one or more computing devices 106 associated with the active users 102 within a cell 104. The one or more parameters may include, but not limited to a network Key Performance Indicator (KPI), an alarm, a fault, and the like. The at least one data packet may be received from the one or more computing devices 106 based on a predefined time. In an embodiment, the predefined time may pertain to the aggregation of the at least one data packet in an hourly bin on a daily basis.

In an embodiment, the system 110 may analyze the at least one data packet to identify one or more patterns of a time series, and correlate with the one or more parameters. The one or more patterns may include, but not limited to, a trend, a seasonality, a white noise, a random noise, and the like. The time series represents a set of one or more observations, with each observation associated with a specific time index.

In an embodiment, the system 110 may predict a lean hour of the one or more computing devices 106 based on the time series forecasting of the analyzed data. The time series forecasting may be based on sorting the at least one data packet and eliminating one or more outliers to predict the lean hour of the one or more computing devices 106. Further, the lean hour of the one or more computing devices 106 may be predicted based on one or more category of the active users 102 of the one or more computing devices 106. The one or more category may include at least one of a lightly loaded category, a moderately loaded category, and a heavily loaded category.

In another embodiment, the system 110 may verify whether the status of the one or more computing devices 106 corresponds to the lean hour. Further, an activity time may be scheduled by the system 110 for the one or more computing devices 106 based on the lean hour. The activity time may pertain to executing network service impacting configuration change operations in the one or more computing devices 106. The network service impacting configuration change operations may include, but not limited to: a firmware upgrade, a network equipment reconfiguration, a network service migration, and an optimization of the network capacity, and the like. Finally, the system 110 may perform changes in the configuration of the one or more computing devices 106 in the lean hour to minimize the active users 102 and optimize service outage impact in the network 108.

In an exemplary embodiment, the communication network 108 may include, but not be limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. In an exemplary embodiment, the communication network 108 may include, but not be limited to, a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof. In exemplary embodiment the communication network 108 includes but not limited to a second generation network, a third generation network, a fourth generation network, a fifth generation network, a 3GPP network, and a non-3GPP network, and the likes.

In an embodiment, the one or more computing devices 106 may communicate with the system 110 via a set of executable instructions residing on any operating system. In an embodiment, the one or more computing devices 106 may include, but not be limited to, any electrical, electronic, electro-mechanical, or an equipment, or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the one or more computing devices 106 may include one or more in-built or externally coupled accessories including, but not limited to, a visual aid device such as camera, audio aid, a microphone, a keyboard, input devices for receiving input from the user 102 such as touch pad, touch enabled screen, electronic pen, receiving devices for receiving any audio or visual signal in any range of frequencies, and transmitting devices that can transmit any audio or visual signal in any range of frequencies. It may be appreciated that the one or more computing devices 106 may not be restricted to the mentioned devices and various other devices may be used.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

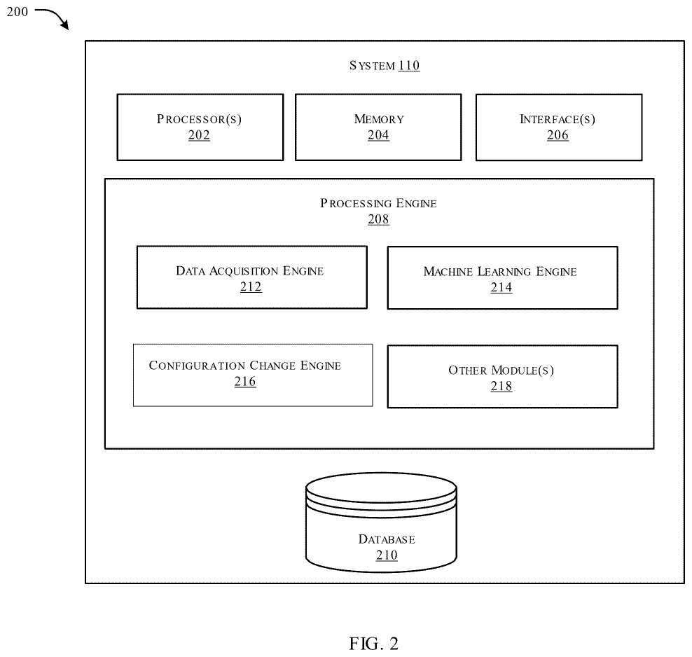

FIG. 2 illustrates an exemplary block diagram 200 of the proposed system 110, in accordance with an embodiment of the present disclosure.

FIG. 2, with reference to FIG. 1, illustrates an exemplary representation of the system 110 for optimizing service outage impact by minimizing active users in a network, in accordance with an embodiment of the present disclosure. In an aspect, the system 110 may comprise one or more processor(s) 202. The one or more processor(s) 202 may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 110. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as Random Access Memory (RAM), or non-volatile memory such as Erasable Programmable Read-Only Memory (EPROM), flash memory, and the like.

Referring to FIG. 2, the system 110 may include an interface(s) 206. The interface(s) 206 may comprise a variety of interfaces, for example, interfaces for data input and output devices, referred to as I/O devices, storage devices, and the like. The interface(s) 206 may facilitate communication to/from the system 110. The interface(s) 206 may also provide a communication pathway for one or more components of the system 110. Examples of such components include, but are not limited to, processing unit/engine(s) 208 and a database 210.

In an embodiment, the processing unit/engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 110 may comprise the machine-readable storage medium storing the instructions and the processing resource to execute the instructions, or the machine-readable storage medium may be separate but accessible to the system 110 and the processing resource. In other examples, the processing engine(s) 208 may be implemented by electronic circuitry.

In an embodiment, the database 210 may comprise data that may be either stored or generated as a result of functionalities implemented by any of the components of the processor 202 or the processing engines 208. In an embodiment, the database 210 may be separate from the system 110.

In an exemplary embodiment, the processing engine 208 may include one or more engines selected from any of a data acquisition engine 212, a machine learning engine 214, a configuration change engine 216, and other engine 218 such as, but not limited to, data computing engine, data analyzing engine, and data sorting engine. The processing engine 208 may further be dedicated for executing complex schematic processing but not limited to the like.

In an embodiment, the data acquisition unit 212 may receive at least one data packet including one or more parameters from one or more computing devices 106 of FIG. 1. In an embodiment, the one or more parameters may include, but not be limited to, a network KPI, an alarm, and a fault.

In an embodiment, the machine learning engine 214 may predict a lean hour of a cell 104 by using the time series analysis which may be a machine learning algorithm.

In an embodiment, the configuration change engine 216 may execute network service impacting configuration change operations in the one or more computing devices 106.

It may be appreciated that the components of the system 110 may be flexible to accommodate changes.

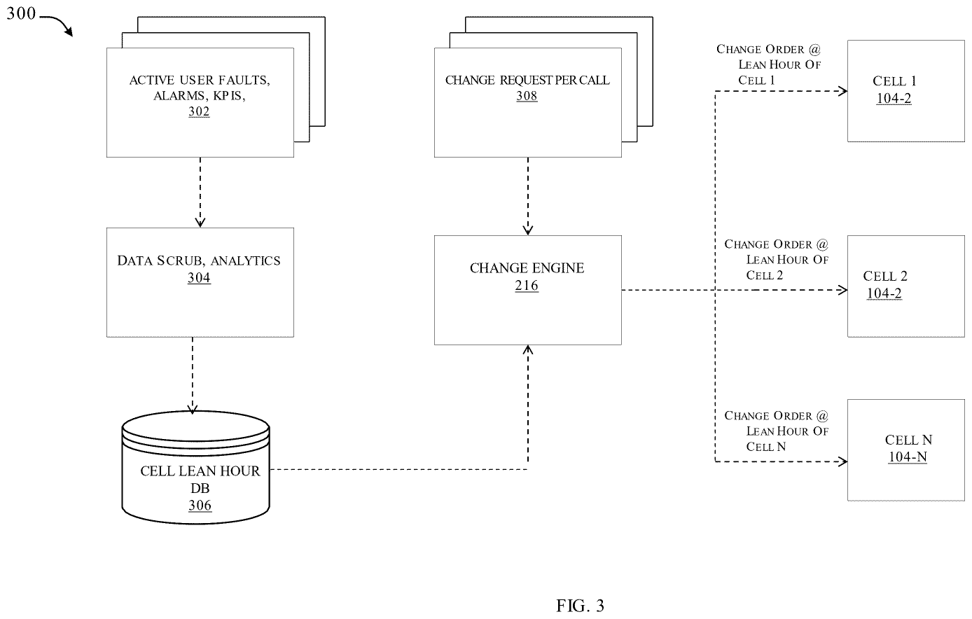

FIG. 3 illustrates an exemplary representation 300 of the process block diagram architecture, in accordance with an embodiment of the present disclosure.

As illustrated, the block 302 may represent active users 102, the alarms, the KPIs, the faults (also known as one or more parameters) in the network. The one or more parameters along with the list of the one or more active users 102 may be sent to block 304 for scrubbing the data, and performing analytics. Further, at block 304, data scrub and analytics may be performed to obtain a cell lean hour for a computing device 106 within at least one cell 104. Further, the data may be stored in a cell lean hour database 306. The output from the database 306 may be transmitted to a change engine 216, where change request per cell may be further stored. The change engine 216 may then provide a parameter change order at lean hour at cell 1 (104-1), cell 2 (104-2), and cell 3 (104-3).

In an embodiment, the parameter change may be applied to each cell 104 in respective lean hour resulting in enormous reduction in number of active users 102 being impacted by the outage required to carry out that change. Mathematically, the number of active subscribers in the cell's lean hour may be represented as:

$$S C 1 + S C 2 + SC 3 + … > SLC 1 + SLC 2 + SLC 3 + … SLCn$$

Where S=Number of active subscribers in a cell in any hour of change.
C1, C2, C3 . . . Cn=Cell numbers from 1 to n in a network
SL=Number of active subscribers in a cell's lean hour.

In an embodiment, the lean hour of each cell may be predicted for each day and the change application may happen at the lean hour of the cell.

In an embodiment, the lean hour may be predicted, with reasonable (>90%) accuracy using time series forecasting given by {Xₜ}, t∈T.

In an embodiment, a ‘Time Series’ may be a collection of observations indexed by time. The observations each occur at some time t, where t belongs to the set of allowed times, T, where T may be discrete in which case, there is a discrete time series, or it may be continuous in the case of continuous time series. Further, one observation of the time series {Xₜ} may be referred as a realization of the series. The time series may consist of distinct patterns including, but not limited to, a trend, a seasonality, a white noise, and a random noise.

In an embodiment, the trend may refer to the slope at an area of the time series. For example, if data is trending upwards in general over a certain time period, then there may be a scenario of data being trending downwards. Series with trend may generally not be stationary, as the mean changes depending on the time. Dealing with trend involves elimination by differencing or a backshift operator. In an embodiment, the seasonality may refer to a repeating pattern, which may be weekly, yearly, or at some other fixed interval. Seasonality may represent a repeated and clear change in a time series. Fitting seasonality may be done using harmonic regression, for example, fitting the series with many sine and cosine (a simplification). Thus, by using different time series model, the system 110 may predict the lean hour count for each cell. In addition, the system 110 may predict the lean hour count for each cell based on the history.

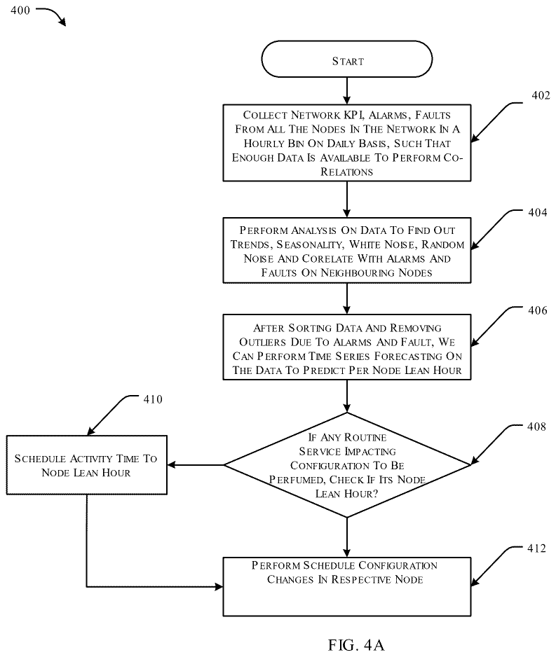

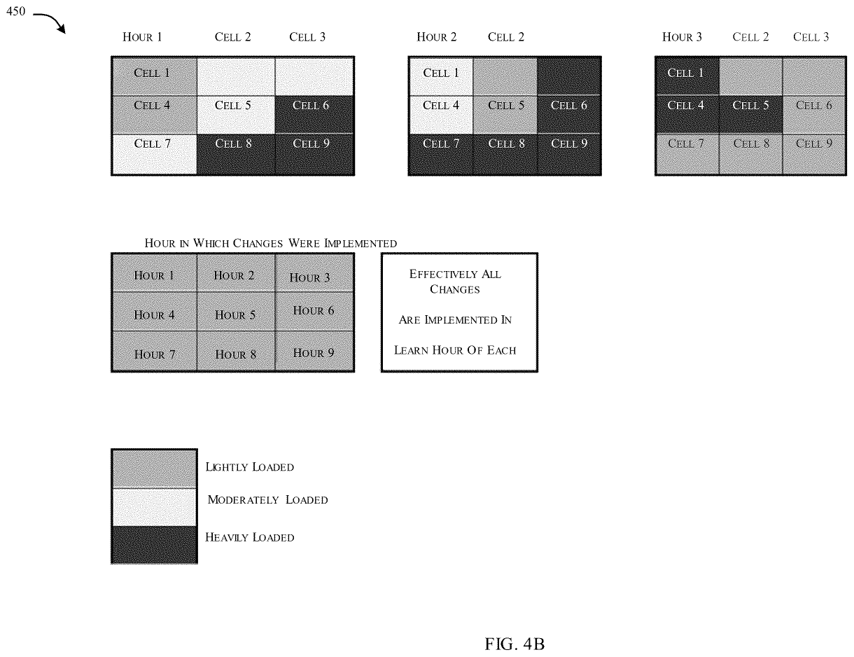

FIG. 4A illustrates an exemplary flow diagram 400 of the proposed method, in accordance with an embodiment of the present disclosure.

As illustrated, the method 400 may include, at step 402, collecting network KPIs, alarms, faults from all the nodes in the network in an hourly bin on a daily basis such that enough data is available to perform correlations. At step 404, the method 400 may include performing analysis on data to find out trends, seasonality, white noise, random noise, etc., and correlate with alarms and faults on neighbouring nodes. At step 406, the method 400 may include performing time series forecasting on the data to predict per node lean hour, after sorting the data and removing outliers due to alarms and faults. Further, at step 408, the method 400 may include checking if any routine service impacting configuration is to be performed and whether it is the cell node lean hour. If it is the lean hour, then the method may include, at step 412, performing schedule configuration in respective node. If it is not the lean hour, then at step 410, the method 400 may first include scheduling activity time to node lean hour before moving to step 412.

FIG. 4B illustrates an exemplary representation 450 of active user loading in a network in different hours in a day, in accordance with embodiments of the present disclosure.

FIG. 4B illustrates a working example of a proposed mechanism for optimizing service outage based on a geography, where different cells may be loaded with different number of active users 102 in different hours and how the proposed method 400 executes the changes in the lean hour of each individual cell resulting in a service disruption experienced by minimum active users. The lean hour of one or more computing devices 106 may be predicted based on one or more category of the active users 102 of the one or more computing devices 106, wherein the one or more category may include at least one of a lightly loaded category, a moderately loaded category, and a heavily loaded category.

In an embodiment, the system 110 receives the one or more parameters from the one or more computing devices 106 based on a predefined time which may pertain to the aggregation of the at least one data packet in an hourly bin on a daily basis. For instance, at hour 1, the cell 1 and cell 4 may fall under the lightly loaded category. The cell 2, cell 3, cell 5, and cell 7 may fall under the moderately loaded category. The cell 6, cell 8, and cell 9 may fall under the heavily loaded category. At hour 2, the cell 2 and cell 5 may fall under the lightly loaded category. The cell 1 and cell 4 may fall under the moderately loaded category. The cell 3, cell 6, cell 7, cell 8, and cell 9 may fall under the heavily loaded category. At hour 3, the cell 2, cell 3, cell 6, cell 7, cell 8, and cell 9 may fall under the lightly loaded category. The cell 1, cell 4, and cell 5 may fall under the heavily loaded category. Thus, FIG. 4B represents all the configuration changes implemented in lean hour.

In an example embodiment, Table 1 and Table 2 highlight observations during a trial on a circle, and post network analysis. The Table 1 refers to analysis conducted on a particular date, and Table 2 refers to analysis conducted on the next day. With the below data, it may be clear that every node has a different lean hour and performing a network activity in a network lean hour may not be an optimal solution.

TABLE 1

| | |
|---|---|
| Network Lean Hour connected count | 823706 |
| Bouncing Lean hour Connected Count | 478693 |
| Reduction | 345013 |
| % Reduction | 42 |

TABLE 2

| | |
|---|---|
| Network Lean Hour connected count | 841672 |
| Bouncing Lean hour Connected Count | 502554 |
| Reduction | 339118 |

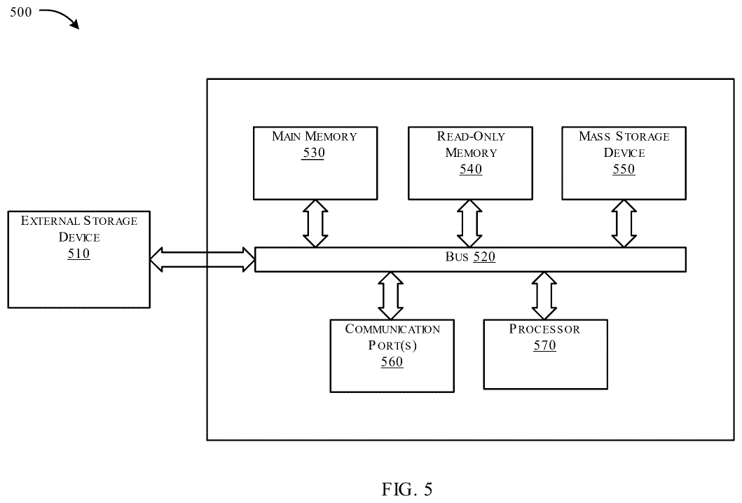

FIG. 5 illustrates an exemplary computer system 500 in which or with which embodiments of the present disclosure may be implemented. In an embodiment, a UE such as, the UE 106 of FIG. 1 and/or the proposed system 110 of FIG. 1 or 2 may be implemented as the computer system 500.

As shown in FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication ports. The processor 570 may include various modules associated with embodiments of the present disclosure. The communication port(s) 560 may be any one of an RS-232 port for use with a modem based dialup connection, a 10/100 Ethernet port, a Gigabit or 10 Gigabit port using copper or fibre, a serial port, a parallel port, or other existing or future ports. The communication port(s) 560 may be chosen depending on a network, or any network to which the computer system 500 connects. The main memory 530 may be Random Access Memory (RAM), or any other dynamic storage device commonly known in the art. The read-only memory 540 may be any static storage device(s). The mass storage device 550 may be any current or future mass storage solution, which can be used to store information and/or instructions.

The bus 520 communicatively couples the processor(s) 570 with the other memory, storage, and communication blocks. Optionally, operator and administrative interfaces, e.g. a display, keyboard, and a cursor control device, may also be coupled to the bus 520 to support direct operator interaction with the computer system 500. Other operator and administrative interfaces can be provided through network connections connected through the communication port(s) 560. Components described above are meant only to exemplify various possibilities. In no way should the aforementioned exemplary computer system 500 limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides a system and a method for optimizing service outage impact by minimizing active users in a network.

The present disclosure facilitates enhanced mechanism for executing configuration changes in the network by enabling the changes in individual cell lean hour to minimize the number of active users experiencing the service disruption.

The present disclosure facilitates user scalability and flexibility according to the requirement of the individual active user during configuration changes.

The present disclosure minimize temporary disruption of services due to which users may not encounter data packet loss, leading to errors or incomplete transmission of data, resulting in disrupted or degraded user experiences.

The present disclosure facilitates schedule service impacting configuration changes during off-peak hours or low-demand periods to minimize the number of active users affected.

The present disclosure provides enhanced user satisfaction by minimizing the number of users affected by a service disruption which helps maintain a higher level of user satisfaction.

The present disclosure conducts service impacting configuration changes during lean hour provides the network administrators with a less congested and more manageable environment for implementing the changes.

The present disclosure facilitates smoother implementation processes, reduced risk of errors, and improved overall efficiency.

1. A system for optimizing service outage impact in a network, the system comprising:
one or more processors; and
a memory operatively coupled with the one or more processors, wherein said memory stores instructions which, when executed, cause the one or more processors to:
receive at least one data packet, comprising one or more parameters, from one or more computing devices associated with one or more active users within at least one cell;
analyze the at least one data packet to identify one or more patterns of a time series, and correlate with the one or more parameters;
predict a lean hour of the one or more computing devices based on time series forecasting of the at least one data packet; and
perform changes in a configuration of the one or more computing devices in the lean hour to minimize the one or more active users and optimize service outage impact in the network.

2. The system as claimed in claim 1, wherein the one or more parameters comprise at least one of: a network Key Performance Indicator, an alarm, and a fault.

3. The system as claimed in claim 1, wherein the one or more patterns comprise at least one of: a trend, a seasonality, a white noise, and a random noise.

4. The system as claimed in claim 1, wherein the one or more processors are configured to:
receive the at least one data packet from the one or more computing devices based on a predefined time, wherein the predefined time pertains to an aggregation of the at least one data packet in an hourly bin on a daily basis.

5. The system as claimed in claim 1, wherein the one or more processors are configured to:
verify whether a status of the one or more computing devices corresponds to the lean hour; and
schedule an activity time for the one or more computing devices based on the lean hour, wherein the activity time pertains to executing network service impacting configuration change operations in the one or more computing devices.

6. The system as claimed in claim 5, wherein the network service impacting configuration change operations comprise at least one of: a firmware upgrade, a network equipment reconfiguration, a network service migration, and an optimization of a network capacity.

7. The system as claimed in claim 1, wherein the one or more processors are configured to:
obtain the time series forecasting based on sorting the at least one data packet, and eliminate one or more outliers to predict the lean hour of the one or more computing devices.

8. The system as claimed in claim 1, wherein the lean hour of the one or more computing devices is predicted based on one or more categories of the one or more active users of the one or more computing devices, and wherein the one or more categories comprise at least one of: a lightly loaded category, a moderately loaded category, and a heavily loaded category.

9. The system as claimed in claim 1, wherein the time series pertains to a set of one or more observations, with each observation associated with a specific time index.

10. A method for optimizing service outage impact in a network, the method comprising:
receiving, by one or more processors, at least one data packet, comprising one or more parameters, from one or more computing devices associated with one or more active users within at least one cell;
analyzing, by the one or more processors, the at least one data packet to identify one or more patterns of a time series, and correlate with the one or more parameters; and
predicting, by the one or more processors, a lean hour of the one or more computing devices based on time series forecasting; and
performing, by the one or more processors, changes in a configuration of the one or more computing devices in the lean hour by minimizing the one or more active users and optimizing service outage impact in the network.

11. The method as claimed in claim 10, wherein the one or more parameters comprise at least one of: a network Key Performance Indicator (KPI), an alarm, and a fault.

12. The method as claimed in claim 10, wherein the one or more patterns comprise at least one of: a trend, a seasonality, a white noise, and a random noise.

13. The method as claimed in claim 10, comprising:
receiving, by the one or more processors, the at least one data packet from the one or more computing devices based on a predefined time, wherein the predefined time pertains to an aggregation of the at least one data packet in an hourly bin on a daily basis.

14. The method as claimed in claim 10, comprising:
verifying, by one or more processors, whether a status of the one or more computing devices corresponds to the lean hour; and
scheduling, by one or more processors, an activity time for the one or more computing devices based on the lean hour, wherein the activity time pertains to executing network service impacting configuration change operations in the one or more computing devices.

15. The method as claimed in claim 14, wherein the network service impacting configuration change operations comprise at least one of: a firmware upgrade, a network equipment reconfiguration, a network service migration, and an optimization of a network capacity.

16. The method as claimed in claim 10, comprising:
obtaining, by the one or more processors, the time series forecasting based on sorting the at least one data packet, and eliminating one or more outliers to predict the lean hour of the one or more computing devices.

17. The method as claimed in claim 10, wherein the lean hour of the one or more computing devices is predicted based on one or more categories of the one or more active users of the one or more computing devices, and wherein the one or more categories comprise at least one of: a lightly loaded category, a moderately loaded category, and a heavily loaded category.

18. A user equipment (UE), comprising:
one or more processors; and
a memory operatively coupled with the one or more processors, wherein said memory stores instructions which, when executed, cause the one or more processors to:
identify one or more temporary service disruptions during a configuration process;
transmit at least one data packet including one or more parameters to a system, wherein the one or more parameters comprise at least one of: a network Key Performance Indicators (KPI), an alarm, and a fault; and
receive and execute one or more instructions from the system during a predicted lean hour based on time series forecasting to optimize service outage impact in a network.

19. A non-transitory computer readable medium comprising machine executable instructions that are executable by one or more processors to:
receive at least one data packet comprising one or more parameters from one or more computing devices associated with one or more active users in a cell;
analyze the at least one data packet to identify one or more patterns of a time series, and correlate with the one or more parameters;
predict a lean hour of the one or more computing devices based on time series forecasting of the at least one data packet; and
perform changes in a configuration of the one or more computing devices in the lean hour to minimize the one or more active users and optimize service outage impact in a network
